(19) United States
(12) Patent Application Publication
(10) Pub. No.: US 2016/0367430 A1
(43) Pub. Date: Dec. 22, 2016

(54) PENIS ENLARGEMENT APPARATUS

(71) Applicant: Chung Hsien LI, Su Lin (TW)

(72) Inventor: Chung Hsien LI, Su Lin (TW)

(21) Appl. No.: 15/183,160

(22) Filed: Jun. 15, 2016

(30) Foreign Application Priority Data
Jun. 17, 2015 (TW) 104209694

(51) Int. Cl. A61H 19/00

(52) U.S. Cl. CPC A61H 19/30

(57) ABSTRACT

Provided are methods and devices of a sports and recreation apparatus for enhancing the penis of a male individual, that can be quickly equipped with ease on the penis as support and slowly pull and extend the penis over time to healthily increase the length of the penis.

### CROSS-REFERENCE TO RELATED APPLICATIONS

The present application claims priority under 35 USC §119 to Taiwan application No. 104209694 filed on Jun. 17, 2015, the entire contents of which are hereby incorporated by reference.

### FIELD OF THE INVENTION

The present invention relates generally to the methods and devices of a sports and recreation apparatus for enhancing the penis of a male individual, that can be quickly equipped with ease on the penis as support and slowly pull and extend the penis over time to healthily increase the length of the penis.

### BACKGROUND OF THE INVENTION AND RELATED ART

The common penis enlargement apparatus utilizes plastic rings and two dynamic metal rods. The metal rods utilize a screwing mechanism to adjust the traction force, rotating the metal rods to adjust the length. The metallic material is hard and heavy and the method of adjusting the length by rotation the rod is relatively inconvenient and the overall design can easily damage the penis.

### SUMMARY OF THE INVENTION

In light of the problems and deficiencies inherent in the prior art, the present invention seeks to overcome these by utilizing a more convenient length and traction force and replacing the materials with a softer and more elastic material.

In accordance with the invention as embodied and broadly described herein, the present invention features a Penis Enlargement Apparatus with extension rods made from a elastic plastic material with moderate hardness. The extension rod is then hook at the cog end to the fasteners of the stationary tubes, slowly towing the leading edge of the mobile seat forward with the extension rods. There is a elastic member that can be put around the glans of the penis. The serrations portion of the front end of the elastic member is fixed at the latch of the mobile seat and create a tension force between the base that is located at the root of the penis and the mobile seat located at the glans of the penis as the extension rods extend. This method and device can be used for penises of all sizes and will not affect walking or everyday life activities.

With the above technology the inventor has invented a type of penis enlargement apparatus where the flat end of the stationary tubes are inserted into the two notches of the base, the flange on either side of the flat end fits into the anchor holes of the base and anchoring the stationary tubes. The extension rods of the mobile seat is then inserted into the stationary tubes with the fasteners inserted into the positioning holes of the stationary tubes so that the buckles are in position with the cogs of the extension rods. The retaining unit of the elastic member of the mobile seat is fixed at a bottom of a circular hole while the other end passes through the other circular hole forming a loop. The present invention comprised of the above elements and method is a simple structure yet highly useful penis enlargement apparatus.

### BRIEF DESCRIPTION OF THE DRAWINGS

FIG. 1 illustrates a exploded view of the penis enlargement apparatus according to one exemplary embodiment of the present invention;

FIG. 2 illustrates a cut-away side view of the extension rod;

FIG. 3 illustrates a top view of the elastic member;

FIG. 4 illustrates a perspective view of the penis enlargement apparatus according to one exemplary embodiment of the present invention.

### DETAILED DESCRIPTION OF EXEMPLARY EMBODIMENTS

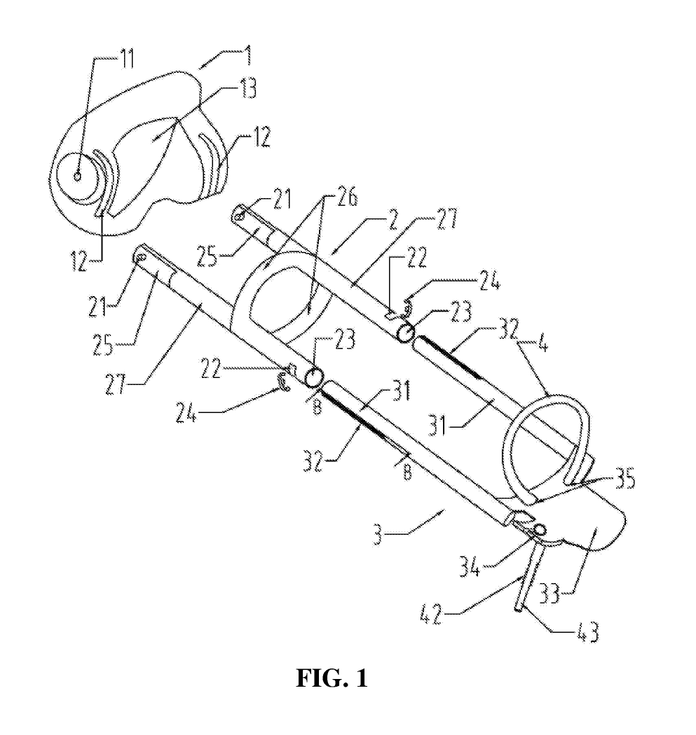

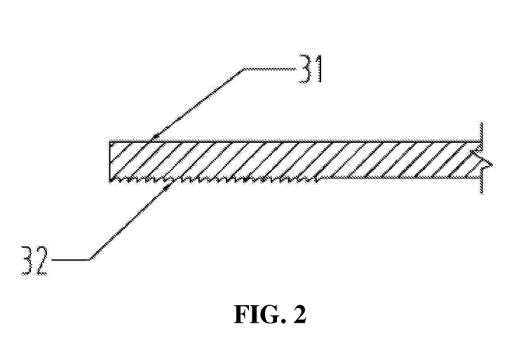

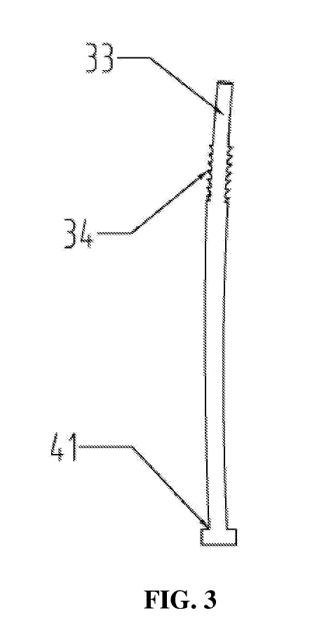

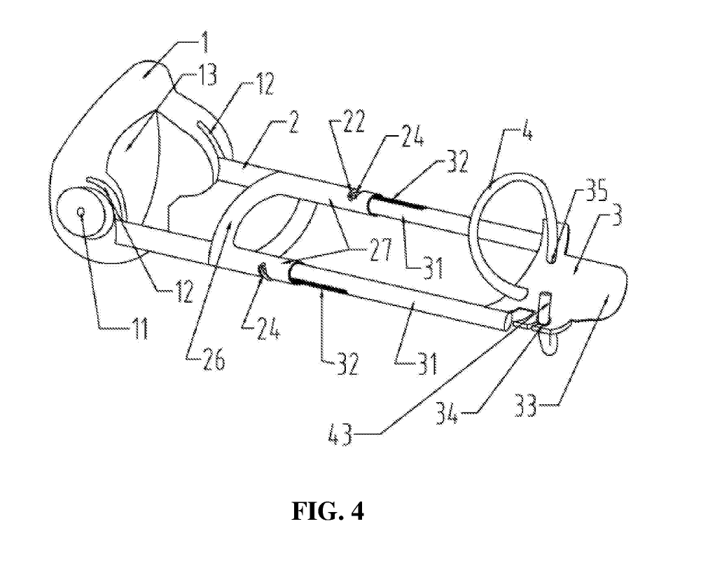

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art practice the invention, it should be understood that other embodiments may be realized and that various changes to the invention may be made without departing from the spirit and scope of the present invention. Thus, the following more detailed description of the embodiments of the present invention, as represented in FIGS. 1 through 4, is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals throughout.

With reference to FIG. 1, the present invention features and describes a method and device for enlarging the penis comprising of a base 1, a stationary base 2, a mobile seat 3 and a elastic member 3 that is fixed on the mobile seat 3, where the materials of the listed parts are of elastic plastic material with moderate hardness. The left and right side of base 1 each has a anchor hole 11, and an opening 13 in the center. In front of opening 13 has two long notches 12. The stationary base is located in front of base 1, with two stationary tubes 27, where one end of the stationary tubes 27 has flat ends 25 which would fit in the notches 12 of base 1 and each flat end 25 has flanges 21 on both sides. Between both stationary tube 27 is a reinforcing ring 26, and in front of the reinforcing ring 26 is two through holes 23, while the outside of the reinforcing ring 26 has a positioning hole 22 paired with a buckle 24. The mobile seat 3 is located in front of the stationary tubes 27 has two extension rods 31. The end of the extension rods 31 has cogs 32 that are specially designed, where when the cogs 32 are latch by the buckle 24 and be unable to move backwards. The mobile seat has 2 circular holes 35 and a leading edge 33, and on one side is a latch 34, which is a inner cone shaped hole. The elastic member 4 is also fixed at the mobile seat, where the back end of the elastic member 4 is a retaining portion 41 with a larger radius than the rest of the elastic member 4. The front end 43 of the elastic member 4 is a serration portion 42, which the front radius is slightly smaller and can pass through the latch 34 of the mobile seat 3.

Each of the flat end 25 of the stationary tube 27 goes in one of the two notches 12 of the base 1. The flange 21 of the flat end 25 would fit in the anchor holes 11 to fix the position. Each of the extension rod 31 of the mobile seat 3 are inserted into the stationary tubes 27, and the buckles 24 are inserted to the positioning holes 22, where the buckles 24 will latch to the cog 32 of the extension rods 31. The retaining portion 41 of the elastic member 4 of the mobile seat 3 is fixed at the bottom side of one of the circular holes 35, while the front end 43 passes through the other circular hole 35 forming a loop. The above referenced parts come to form an exemplary embodiment of the present invention, which is a structurally simple yet effective penis enlargement apparatus.

The penis would go through opening 13 of base 1 and loop the elastic member 4 around the glans of the penis, then adjust the size of the loop from the elastic member 4 and put the serration portion 42 of the front end 43 of the elastic member 4 through the latch 34 of the mobile seat 3 to fix its position. By slowly pulling the leading edge 33 of the mobile seat 3 forward, and the extension rod 31 will also move forward, and create a tension force between the mobile seat 3 and the base 1. The present invention can be used for penises of any size and will not cause pain or affect walking or any every day activities, and increase the length slowly over time, not just making the penis longer, but also healthier.

1. A penis enlargement apparatus comprising:
A base, with anchor holes on the side and an opening in the center, with long notches on the front end of the opening;
A stationary base next to said base with stationary tubes, and at the back end of said stationary tubes are flat ends which can fit in said notches of said base, and said flat ends has flanges on the two sides while said stationary tubes are connected by reinforcement rings along said stationary tubes, at the opposite end of said stationary tubes are through holes while positioning holes are set on the outside circumference of said through holes and is paired with buckles;
a mobile seat next to the front end of said stationary tubes, with extension rods, and the back end of said extension rods have cogs which can be fixed by said buckles to prevent backwards movement, said mobile seat has circular holes and moveable leading edge with a latch on sides, where said latches are cone shaped through holes; and
an elastic member on the mobile seat, where the back end has a retaining portion with a larger diameter, and the front end has a serration portion where the front end of said serration portion has a smaller diameter which can fit through said latches.

2. The penis enlargement apparatus of claim 1, wherein said flat end of said stationary tubes are inserted in said notches of said base, and said flanges of said flat end fit into said anchor holes.

3. The penis enlargement apparatus of claim 1, wherein said extension rods of said mobile base fitting in said fixing tubes, with said buckle inserted in said positioning holes, where said buckle is located next to said latches of said extension rods.

4. The penis enlargement apparatus of claim 1, wherein said retaining portion of said elastic member is retained at the bottom of said circular hole, while the front end goes through another said circular hole forming a ring shape, and said serration portion of said elastic member can go through said latch of said mobile seat.

5. The penis enlargement apparatus of claim 1, wherein said base, said stationary base, said mobile seat and said elastic member are plastic material with elastic characteristics and moderate hardness.
